(19) United States
(12) Patent Application Publication
(10) Pub. No.: US 2025/0158725 A1
(43) Pub. Date: May 15, 2025

(54) REAL-TIME TRANSMISSION LINE QUALITY MEASUREMENT METHOD APPLIED TO A 5G RADIO TRANSCEIVER SYSTEM

(71) Applicant: VIETTEL GROUP, Ha Noi City (VN)

(72) Inventors: XUAN MANH TRAN, Tien Lu District (VN); DINH HAI TRUYEN HOANG, Ha Noi City (VN); QUANG LINH NGUYEN, Ha Noi City (VN); MINH CANH TRAN, Nha Trang City (VN); VAN SON NGUYEN, Ha Noi City (VN); TIEN SANG NGUYEN, Hai Hau District (VN); XUAN THANG NGUYEN, Ha Noi City (VN); PHI DAC NGUYEN, Hung Nguyen District (VN); TUAN DUC VU, Ha Noi City (VN)

(73) Assignee: VIETTEL GROUP, Ha Noi City (VN)

(21) Appl. No.: 18/924,267

(22) Filed: Oct. 23, 2024

(30) Foreign Application Priority Data
Nov. 15, 2023 (VN) 1-2023-08083

(51) Int. Cl. H04B 17/309; H04B 1/40; H04L 5/00

(52) U.S. Cl. CPC H04B 17/309; H04B 1/40; H04L 5/0007; H04L 5/0048

(57) ABSTRACT

The invention proposes a method for measuring the quality of real-time transmission lines applied to 5G radio transceiver systems, allowing for immediate error detection, thereby providing solutions to ensure the system is always in a stable operating condition. The method is implemented in three steps: step 1: transmitting and receiving reference signals on the 5G radio transceiver system; step 2: estimating the channel response of each transmission channel, calculating the received signal power on each channel; step 3: evaluating the status of the transmission channel.

### TECHNICAL FIELD COVERED

The invention proposes a method for measuring the quality of real-time transmission lines applied to 5G radio transmission systems. Specifically, the proposed method aims to help 5G radio transmission equipment (RRU—Radio Remote Unit) to be able to measure and evaluate the quality of transmission lines during operation without the need for additional external measurement equipment.

### BACKGROUND OF THE INVENTION

FIG. 1 describes the processing components on the transmission line of the 5G transceiver, the roles of the functional blocks are described in detail as follows:
Front Haul interface (FH): performs data extraction received from messages sent from the central processing unit (Distribution Unit—DU 5G NR).
Central processing unit on RRU (Advanced Reduced instruction set computer Machines—ARM): generates reference data sequences for all antenna channels and calculates channel estimation parameters for transmitting antenna channels.
Orthogonal Frequency Division Multiplexing (OFDM) modulation block: performs signal conversion from frequency domain to time domain.
OFDM orthogonal frequency division multiplexing demodulation block: performs time-to-frequency conversion.
Digital signal processing block: performs a number of processes to improve data quality such as filtering, increasing the sampling rate to intermediate frequency (IF), and compensating for nonlinear distortion.
Digital to analog converter (DAC): the digital signal after being digitally processed to improve quality that will be sent to the digital to DAC block. The digital signal will be converted to analog domain and mixed to the radio center frequency.
Analog Digital Converter (ADC): The analog signal here will be processed by mixer block. At base-band frequency, it will be sampled and converted to digital domain.
Radio interface: performs digital data communication between the digital signal processing part and conversion components such as ADC/DAC.
Power amplifier: amplifies the power of the transmitted signal before emitting it into the environment.
High frequency filter: filters out unwanted, out-of-band signals before emitting them into the environment through the antenna.
Antenna component: in addition to the function of emitting signals into the environment, the antenna is also designed with the function of extracting a part of the signal from the transmitting channels and then adding them together.

The signal after adding is transmitted back via the feedback data line. FIG. 2 describes in detail the extraction of signals from eight transmitting channels to the feedback data line at the antenna.

For a 5G radio transceiver system in half-duplex mode (Time Duplexing Division—TDD), the basic transmit/receive frame is defined as a period of 10 ms. Within these 10 ms, the frame is divided into twenty smaller time slots of 0.5 ms length; each corresponding time slot is assigned to perform the function of receiving and transmitting or both. For each 0.5 ms time slot, the frame is further divided into transmission symbols with an average length of 33 us.

Radio transmission and reception systems operating for a long time may experience the following conditions:
Degradation of transmission line quality due to aging of semiconductor components.
Loss of impedance matching between coupled components.
The power amplifier biasing on the channels fails.
High frequency cables break and degrade over time.
The power amplifier is damaged.

These causes all lead to the same consequence, which is the degradation of the quality of the emitted signal (complete loss or poor quality). However, after deploying the equipment outside the radio transceiver stations, detection and inspection will be very difficult. Moreover, detection must be timely to have a quick handling plan, avoiding affecting service users.

### BRIEF SUMMARY OF THE INVENTION

The purpose of the invention is to propose a method to solve the above problem. Specifically, the invention will provide a method for measuring real-time channel quality and allow for continuous measurement while the 5G radio transceiver system is operating without the need for additional device support other measurements and does not affect service quality. From continuous quality assessment, it is possible to promptly detect problems with the transmission line to come up with timely solutions. To accomplish this, the proposed invention includes the following three steps:

Step 1: Transmit and receive reference signals on the 5G radio transceiver system.
Transmit reference data to each system channel in turn and receive data on the antenna's return path.
The response data for each transmission of different channels will be used to evaluate the impact on the signal.
   Step 2: estimate the channel response of each transmit channel, calculate the received signal power on each channel.
From the reference signal received after transmitting to each channel in turn, calculate the channel response.
Calculate the power of the received signal.

Step 3: Evaluate the channel status
Based on the received signal power on each channel, we will evaluate the status of the transmitting channel according to pre-configured thresholds.

### BRIEF DESCRIPTION OF THE SEVERAL VIEWS OF THE DRAWINGS

FIG. 1: is a drawing describing the functional components on the transmission line of the 5G radio transceiver system (RRU);

FIG. 2: is a diagram showing how to extract the reflected signal from the antenna;

FIG. 3: is a drawing depicting the reference signal processing flow on the 5G radio transceiver unit (RRU);

FIG. 4: is a diagram showing how to create a time domain reference data series;

FIG. 5: is a drawing depicting the OFDM transmission frame of the 5G radio transceiver system and how to extract the feedback signal in half-duplex transceiver mode;

FIG. 6: is a drawing describing the implementation of the invention on a 5G radio transceiver unit (RRU) system;

FIG. 7: is a drawing describing the experimental system to survey the capacity of VHT.

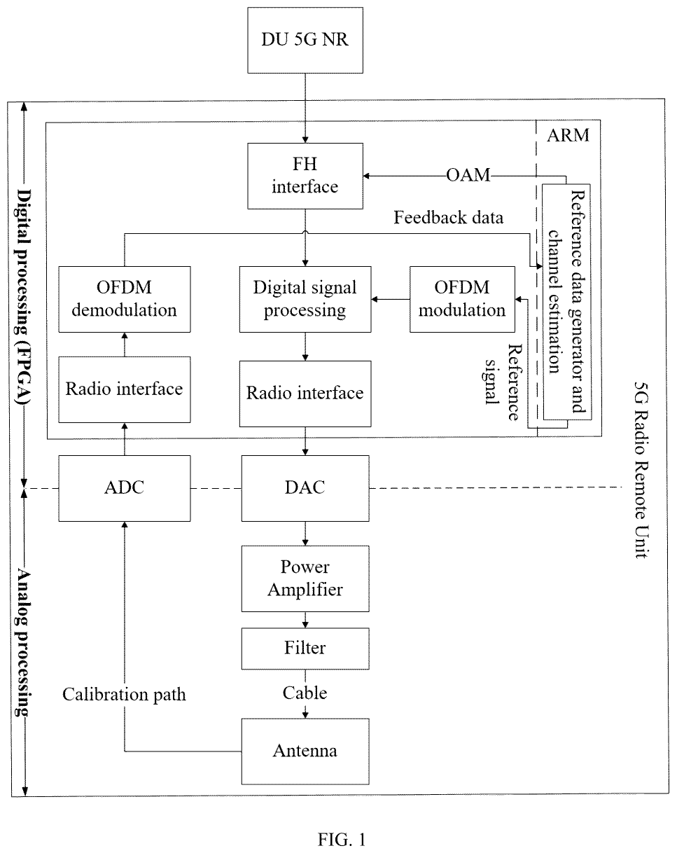

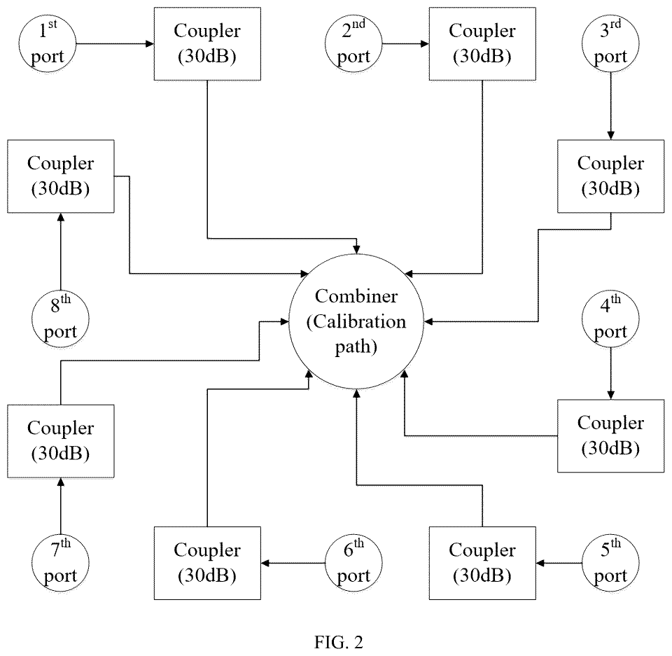

### DETAILED DESCRIPTION OF THE INVENTION

When operating the 5G radio transmission system for a long time, there are two parts that are most likely to be damaged: the high-frequency cable and the power amplifier. To detect this situation in practice is not easy because radio transceiver equipment is deployed very high, without specialized measurement systems it will not be detected.

In this invention, a reference signal is used to transmit successively to the antenna's transmission channels, based on the power of the signal reflected back though the feedback channel to calculate and evaluate the quality of the transmission channel. This allows continuous monitoring to give timely warnings to the system.

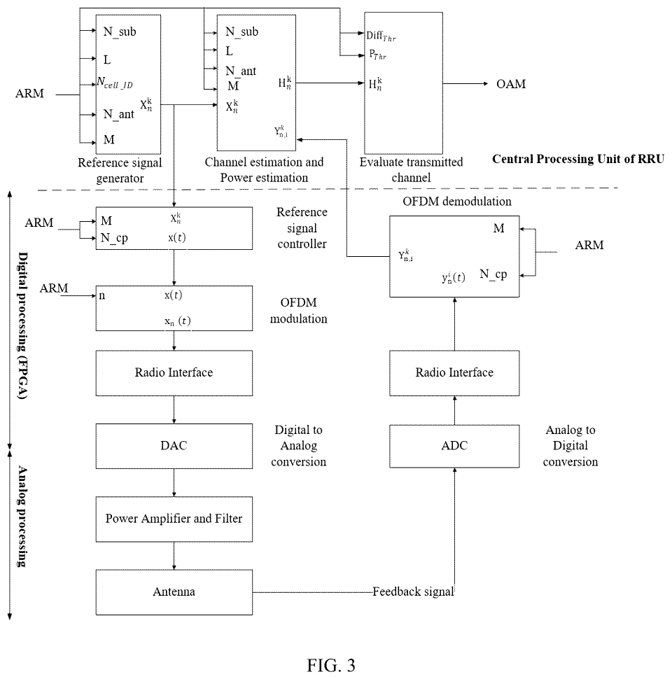

FIG. 3 describes the input/output parameters of the processing blocks of the transmission line quality measurement method in the system as shown in Table 1.

TABLE 1
Input/output parameters at processing blocks

| Signal | Description |
|---|---|
| N_sub | Parameter indicating the number of subcarriers in the |
| | bandwidth of the 5G radio transceiver system. |
| L | The parameter specifies the iterations of the data phase |
| | correction factor calculation process. |
| N_{cell}_ID | Identifier parameter for 5G radio transceiver. |
| N_ant | Parameter indicating the number of transmit/receive lines |
| | of the antenna. |
| M | Number of points to calculate fast Fourier transform |
| | (iFFT/FFT). |
| Xₙ^{k} | Frequency domain reference signal sequence. With k is the |
| | subcarrier index, n is the transmit antenna channel index. |
| N_cp | Cyclic Prefix (CP) size for OFDM modulation/ |
| | demodulation. |
| x(t) | Time domain reference data series, since the channels are |
| | transmitting the same type of data, we do not need to |
| | distinguish by antenna channel index. |
| xₙ (t) | The time domain reference data sequence is controlled to be |
| | transmitted to each desired antenna channel in turn. With n |
| | is the antenna channel number from which the data is |
| | transmitted. |
| yₙⁱ (t) | The reference data sequence is obtained from the echo |
| | channel. With i is the iteration number, n is the antenna |
| | channel number. |
| Y_{n,i}^{k} | Frequency domain reference data string obtained from the |
| | feedback channel. With k is the subcarrier index, n is the |
| | antenna channel index and i is the computation iteration |
| | index. |
| Hₙ^{k} | Channel response matrix of antenna channels. With k is the |
| | subcarrier index, n is the antenna channel index. |
| P_{Thr} | Power evaluation threshold, this threshold is used to |
| | evaluate the power of the signal emitted on each |
| | transmitting channel received at the feedback channel. |
| Diff_{Thr} | Power deviation threshold, this threshold is used to |
| | evaluate the signal power emitted on each transmitting |
| | channel received at the feedback channel compared to |
| | the channel with the largest received signal power. |
| Pₙ^{k} | Signal power per received subcarrier. With k is the |
| | subcarrier index, n is the antenna channel index. |
| Pₙ | Signal power on each channel received by the antenna. |
| | With n is the antenna channel index. |
| maxP_{N}_ant | The value of the antenna channel with the highest power |
| | among N_ant channel being transmitted. |
| diffPₙ | The absolute difference in received power on the antenna |
| | channels compared to the value - maxP_{N}_ant. With n is the |
| | antenna channel index. |

The detailed contents of the steps in the invention are presented specifically as follows (refer to FIG. 3):

Step 1: Transmit and receive reference signals on the 5G radio transceiver system. The frequency domain reference signal is generated at the central processing unit on the RRU (ARM) with the following input parameters: number of subcarriers (N_sub), number of antenna channels (N_ant), number of iterations (L), number of fast Fourier transform calculation points (M), and radio device identifier parameter (N_{cell_ID}). This step is presented specifically as follows:

The reference signal is generated from the Zadoff-Chu (ZC) sequence, which can change its bandwidth based on N_sub parameters. When changing the N_{cell_ID} parameters, we will get orthogonal ZC sequence. This helps 5G radio transmitters in neighboring areas not to be cross-interfered with each other during the transmission of reference signal.

The ZC sequence s(n)—used to generate reference data. The sequence is generated in the following formula:

$$s ( n ) = {e}^{j {N}_{{cell}_{ID}} k} {\hat{r}}_{u , v} ( n ) , 0 \leq n \leq {N}_{sub} - 1$$

\hat{r}_{u,v}(n) is named the root sequence, this sequence will be generated according to the following formula:

$${\hat{r}}_{u , v} ( n ) = {x}_{q} ( n mod {N}_{S C}^{R S} ) , 0 \leq n \leq {N}_{s u b} - 1$$

The value (N_{SC}^{RS}) is less than the number of subcarriers in the system bandwidth (N_sub), which is defined in the 3GPP standard for each bandwidth.

x_{q}(m) is called the original string, this original string is calculated b the formula:

$${x}_{q} ( m ) = {e}^{- \frac{j π q m ( m + 1 )}{{N}_{S C}^{R S}}} , 0 \leq m \leq {N}_{S C}^{R S} - 1$$

The q index is calculated by the formula:

$$q = ⌊ \overline{q} + \frac{1}{2} ⌋ + ν \cdot {( - 1 )}^{⌊ 2 \overline{q} ⌋} , v = 0$$

The value is calculated as follows: q̅

$$\overline{q} = {N}_{s c}^{R S} \cdot \frac{u + 1}{31} , u = 0$$

The generated sequence—s(n) is a complex matrix of size 1×N_{sub}, which is also the reference signal at frequency domain (Xₙ^{k}), this sequence will be converted to the time domain by using inverse fast Fourier transform (iFFT) and OFDM modulation. The time domain reference signal—x(t) will be transmitted repeatedly for two OFDM symbols (refer to FIG. 4).

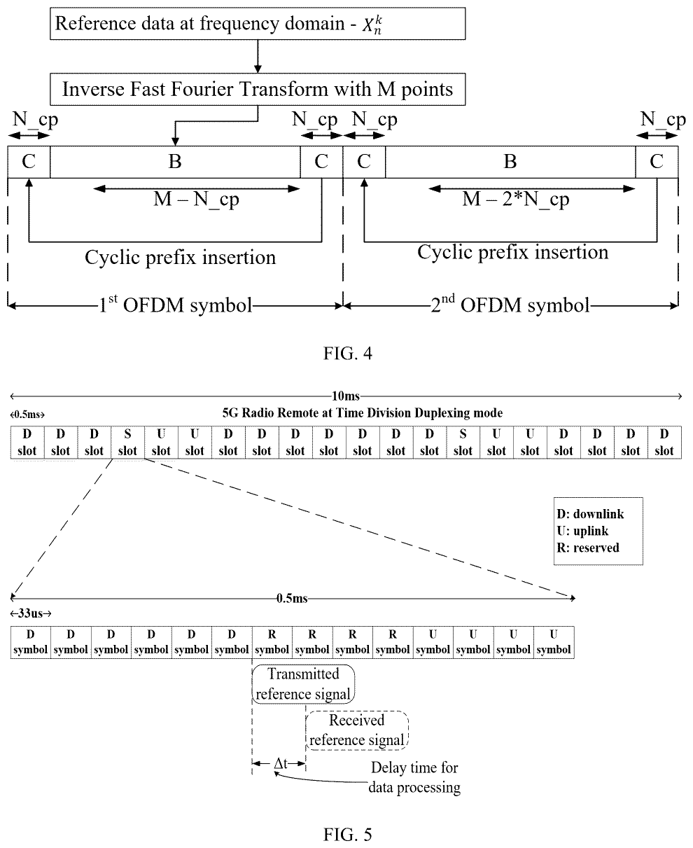

For each OFDM transmission frame, we only transmit reference data once and transmit it on a single antenna channel. Referring to FIG. 5, the reference signal—x(t) will be transmitted on the seventh and eighth OFDM symbols of the special time slot. Because the processing delay on the radio transceiver system is known in advance, after a period of time (Δt), the reference signal—yₙⁱ(t) will be received on the feedback path from the antenna.

Currently, the seventh and eighth OFDM symbols of the special time slot are not scheduled for transmission/reception for users, so we can continuously transmit/receive reference data at this time. This is the factor that helps to realize the continuous real-time monitoring of this monitoring method.

The received signal—yₙⁱ(t) will be demodulated with OFDM and fast Fourier transform (FFT) to obtain a reference data sequence received in the frequency domain. Because the hardware characteristics always change according to external influences (temperature, frequency, etc.), we need to repeat this signal transmission-reception process many times on all antenna channels. The sequences Y_{n,i}^{k} will be stored in the Random Access Memory (RAM) of the central processing unit on the RRU and the average will be calculated for each antenna channel to eliminate the effects of system oscillation as well as increase the accuracy of the algorithm. Applying the average calculation formula in mathematics, each antenna channel will obtain a representative reference data sequence on the feedback path (Y̅ₙ^{k}) calculated according to the formula:

$${\overline{Y}}_{n}^{{}_{k}} = \frac{1}{L} {\sum }_{i = 0}^{L - 1} {Y}_{n , i}^{k} , k = \overline{0 , N\_sub - 1} , n = \overline{0 , {N}_{a n t} - 1}$$

The received signal will be amplitude-calibrated according to the absolute value of the complex number R=1+1i according to the formula:

$${\overline{Y}}_{n}^{{}_{k}} = \frac{Abs ( R )}{Abs ( max ( {\overline{Y}}_{n}^{{}_{k}} ) )} \cdot {\overline{Y}}_{n}^{{}_{k}} , k = \overline{0 , N\_sub - 1} , n = 0 , \overline{{N}_{a n t} - 1}$$

The purpose of signal normalization is to separate the received data from the background noise of the environment, eliminating the influence of the transmitted power on the reference signal.

Step 2: Estimate the channel response of each transmitting channel, calculate the received signal power on each channel. This step is performed entirely on the central processing unit (ARM), the frequency domain reference data obtained in step 1 (Y̅ₙ^{k}) and the original frequency domain reference data (Xₙ^{k}) are used to calculate the signal power on each antenna channel.

The channel response (Hₙ^{k}) is corresponding to each antenna channel on each subcarrier is calculated according to the following formula:

$${H}_{n}^{k} = \frac{{\overline{Y}}_{n}^{{}_{k}}}{{X}_{n}^{k}} {vó}^{{}_{{}_{′}}} i k = \overline{0 , {N}_{sub} - 1} , n = \overline{0 , {N}_{a n t} - 1}$$

The received signal power on each subcarrier of the antenna channels is calculated as follows:

$${P}_{n}^{k} = {( {H}_{n}^{k} )}^{2} {vó}^{{}_{{}_{′}}} i k = \overline{0 , {N}_{sub} - 1} , n = \overline{0 , {N}_{a n t} - 1}$$

The signal power of each antenna channel is the sum of the powers of each subcarrier received on the feedback channel:

$${P}_{n} = {\sum }_{k = 0}^{{N}_{s u b} - 1} {P}_{n}^{k} {vó}^{{}_{{}_{′}}} i n = \overline{0 , {N}_{a n t} - 1}$$

Maximum power received during antenna channel transmission:Nₐₙₜ

$$max {P}_{{N}_{-} a n t} = max \{ {P}_{n} \} {vó}^{{}_{{}_{′}}} i n = \overline{0 , {N}_{a n t} - 1}$$

The power deviation of the antenna channels from the channel with the highest power is calculated by the formula:

$$diff {P}_{n} = \vert max {P}_{{N}_{-} a n t} - {P}_{n} \vert , n = \overline{0 , {N}_{a n t} - 1}$$

Step 3: Channel status evaluation. This evaluation step is processed on the central processing unit (ARM), the power value of each antenna channel (Pₙ) and the power deviation of each antenna channel from the channel with the largest power (diffPₙ) are used as input for this step.

The quality of the transmission channel is assessed based on two criteria: the power of the received reference signal and the power deviation of the transmission channels.

This result is saved in the random access memory of the central processing unit on the RRU and will be transmitted to the DU 5G NR via the operation monitoring line (OAM—Operation, Administration and Maintenance).

ARM configures two parameters: the received signal power threshold on the channel (P_{Thr}) and the power deviation of the channels compared to the channel with the largest received power (Diff_{Thr}) to the evaluation block. The threshold (P_{Thr}) is used to decide whether the transmitting channel is transmitting a signal or not, the threshold (Diff_{Thr}) will indicate which channel is degraded.

The transmit channel will be judged to be not emitting a signal (or not amplifying the emitted signal through the power amplifier block) when:

$${P}_{n} < {P}_{T h r} {vó}^{{}_{{}_{′}}} i n = \overline{0 , {N}_{a n t} - 1}$$

The broadcast channel will be considered degraded (signal gain reduction) when:

$$\{ \begin{matrix}{P}_{n} \geq {P}_{T h r} \\ diff {P}_{n} \geq {Diff}_{T h r}\end{matrix} , n = \overline{0 , {N}_{a n t} - 1}$$

A broadcast channel is considered to be operating normally when the following conditions are satisfied:

$$\{ \begin{matrix}{P}_{n} \geq {P}_{T h r} \\ diff {P}_{n} < {Diff}_{T h r}\end{matrix} , n = \overline{0 , {N}_{a n t} - 1}$$

At the end of step 3, the antenna channels can be evaluated for their operating status (normal operation, gain degradation, no signal amplification) based on the above evaluation results.

### Example of Patent Implementation

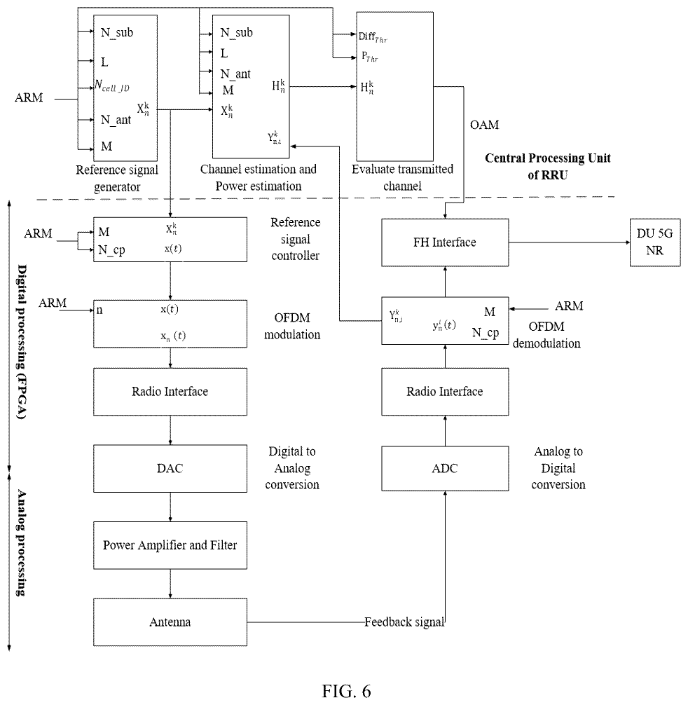

To prove the correctness and effectiveness, the invention has been integrated into the 5G 8T8R RRU product manufactured by Viettel High Technology Industry Corporation (VHT—Viettel) and a survey was conducted to evaluate the effectiveness in VHT's laboratory. The implementation diagram of the invention in the 5G 8T8R RRU design is shown in FIG. 6.

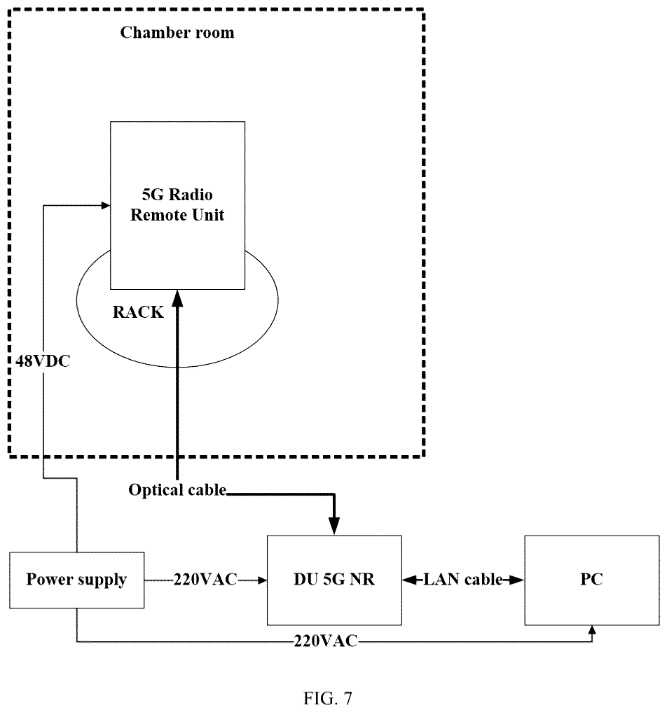

At the same time, a long-term survey experiment was also conducted to find out the appropriate power evaluation threshold (P_{Thr}) and power deviation threshold (Diff_{Thr}) for the 5G radio transmission and reception system developed by VHT—Viettel. FIG. 7 describes the experimental system of the invention. This experiment is conducted to survey the received signal power threshold on each channel (P_{Thr}) and the power deviation of the channels compared to the channel with the largest received power (Diff_{Thr}). From these two thresholds, it will be widely applied to the deployed device network. The technical parameters are described in Table 2.

TABLE 2
parameters of the test system

| STT | Configuration | Value | Unit |
|---|---|---|---|
| 1 | Radio standard | 5G NO | |
| 2 | Duplex mode | TDD | |
| 3 | Bandwidth | 100 | MHz |
| 4 | Operating frequency range | 2496-2690 | MHz |
| 5 | Center frequency | 2.55 | GHz |
| 6 | Number of antenna channels | 32 | Channel |
| 7 | Number of subcarriers | 3276 | subcarrier |
| 8 | Number of calculation iterations | 6 | Time |
| 9 | Fast Fourier transform points | 4096 | Point |
| 10 | Cyclic Prefix (CP) Length | 288 | Sample |
| 11 | Maximum output power per | 40 | W |
| | channel | | |

The measurement system uses a DU 5G NR to transmit data according to 3GPP standards continuously for a long time to a 5G radio transceiver device. After radio processing, data will be emitted into the environment through the antenna. In parallel with data transmission, the system is also continuously monitored according to the method mentioned in the invention. Power parameters will be collected, evaluated and sent to DU 5G NR via OAM monitoring line.

Experiment 1: using a 5G 8T8R RRU capable of transmitting data normally on all eight transmission channels.

The experimental results of the power received on each channel with different transmission levels of the 5G 8T8R RRU are shown in Table 3 with the following parameters:
Pₒᵤₜ: The signal power emitted on each channel is calculated in Watts (W).
P₁: The received signal power on the first channel is calculated in Decibel metter (dBm).
P₂: The received signal power on the second channel is calculated in Decibel metter (dBm).
P₃: The received signal power on the third channel is calculated in Decibel metter (dBm).
P₄: The received signal power on the fourth channel is calculated in Decibel metter (dBm).
P₅: The received signal power on the fifth channel is calculated in Decibel metter (dBm).
P₆: The received signal power on the sixth channel is calculated in Decibel metter (dBm).
P₇: The received signal power on the seventh channel is calculated in Decibel metter (dBm).
P₈: The received signal power on the eighth channel is calculated in Decibel metter (dBm).

TABLE 3
Received signal power levels on each channel
in different transmission power cases

| | P₁ | P₂ | P₃ | P₄ | P₅ | P₆ | P₇ | P₈ |
|---|---|---|---|---|---|---|---|---|
| Pₒᵤₜ(W) | (dBm) | (dBm) | (dBm) | (dBm) | (dBm) | (dBm) | (dBm) | (dBm) |
| 1 | 29.6 | 29.8 | 30 | 29.7 | 30.1 | 29.7 | 29.65 | 29.8 |
| 5 | 30.4 | 30.5 | 30.8 | 30.5 | 30.8 | 30.5 | 30.5 | 30.5 |
| 10 | 32.8 | 33.1 | 33.1 | 33.1 | 33.1 | 32.5 | 32.85 | 33 |
| 20 | 32.6 | 33.3 | 32.8 | 33.1 | 33.1 | 32.9 | 32.987 | 33 |
| 30 | 32.4 | 33.1 | 33.1 | 33.05 | 33.1 | 32.5 | 32.85 | 32.95 |
| 40 | 32.5 | 33.2 | 33.1 | 33 | 33.1 | 32.9 | 32.85 | 33.2 |

Experiment 2: using a 5G 8T8R RRU capable of transmitting data normally on the first seven channels, channel number eight is disconnected from the antenna. This case is to simulate the phenomenon of one or more transmitting channels having a hardware connection failure.

The experimental results of the power received on each channel with different transmission levels of the 5G 8T8R RRU are shown in Table 4 with the following parameters:
Pₒᵤₜ: The signal power emitted on each channel is calculated in Watts (W).
P₁: The received signal power on the first channel is calculated in Decibel—miliwatts (dBm).
P₂: The received signal power on the second channel is calculated in Decibel—miliwatts (dBm).
P₃: The received signal power on the third channel is calculated in Decibel—miliwatts (dBm).
P₄: The received signal power on the fourth channel is calculated in Decibel—miliwatts (dBm).
P₅: The received signal power on the fifth channel is calculated in Decibel—miliwatts (dBm).
P₆: The received signal power on the sixth channel is calculated in Decibel—miliwatts (dBm).
P₇: The received signal power on the seventh channel is calculated in Decibel—miliwatts (dBm).
P₈: The received signal power on the eighth channel is calculated in Decibel—miliwatts (dBm).

TABLE 4
received signal power level on each channel in different transmit power cases

| | P₁ | P₂ | P₃ | P₄ | P₅ | P₆ | P₇ | P₈ |
|---|---|---|---|---|---|---|---|---|
| Pₒᵤₜ(W) | (dBm) | (dBm) | (dBm) | (dBm) | (dBm) | (dBm) | (dBm) | (dBm) |
| 1 | 29.6 | 29.8 | 30 | 29.7 | 30.1 | 29.7 | 29.65 | 8 |
| 5 | 30.4 | 30.5 | 30.8 | 30.5 | 30.8 | 30.5 | 30.5 | 7.8 |
| 10 | 32.8 | 33.1 | 33.1 | 33.1 | 33.1 | 32.5 | 32.85 | 9.1 |
| 20 | 32.6 | 33.3 | 32.8 | 33.1 | 33.1 | 32.9 | 32.987 | 8.7 |
| 30 | 32.4 | 33.1 | 33.1 | 33.05 | 33.1 | 32.5 | 32.85 | 7.5 |
| 40 | 32.5 | 33.2 | 33.1 | 33 | 33.1 | 32.9 | 32.85 | 7.8 |

Experiment 3: Using a 5G 8T8R RRU capable of transmitting normal data on the first seven channels, channel 8 has a degraded power amplifier gain. This case is to simulate the phenomenon of one or more channels having a degraded power amplifier quality.

The experimental results of the power received on each channel with different transmission levels of the 5G 8T8R RRU are shown in Table 5 with the following parameters:
Pₒᵤₜ: The signal power emitted on each channel is calculated in Watts (W).
P₁: The received signal power on the first channel is calculated in Decibel—miliwatts (dBm).
P₂: The received signal power on the second channel is calculated in Decibel—miliwatts (dBm).
P₃: The received signal power on the third channel is calculated in Decibel—miliwatts (dBm).
P₄: The received signal power on the fourth channel is calculated in Decibel—miliwatts (dBm).
P₅: The received signal power on the fifth channel is calculated in Decibel—miliwatts (dBm).
P₆: The received signal power on the sixth channel is calculated in Decibel—miliwatts (dBm).
P₇: The received signal power on the seventh channel is calculated in Decibel—miliwatts (dBm).
P₈: The received signal power on the eighth channel is calculated in Decibel—miliwatts (dBm).

TABLE 5
Received signal power levels on each channel
in different transmission power cases

| | P₁ | P₂ | P₃ | P₄ | P₅ | P₆ | P₇ | P₈ |
|---|---|---|---|---|---|---|---|---|
| Pₒᵤₜ(W) | (dBm) | (dBm) | (dBm) | (dBm) | (dBm) | (dBm) | (dBm) | (dBm) |
| 1 | 29.6 | 29.8 | 30 | 29.7 | 30.1 | 29.7 | 29.65 | 23.7 |
| 5 | 30.4 | 30.5 | 30.8 | 30.5 | 30.8 | 30.5 | 30.5 | 23.5 |
| 10 | 32.8 | 33.1 | 33.1 | 33.1 | 33.1 | 32.5 | 32.85 | 23.9 |
| 20 | 32.6 | 33.3 | 32.8 | 33.1 | 33.1 | 32.9 | 32.987 | 24.1 |
| 30 | 32.4 | 33.1 | 33.1 | 33.05 | 33.1 | 32.5 | 32.85 | 24.5 |
| 40 | 32.5 | 33.2 | 33.1 | 33 | 33.1 | 32.9 | 32.85 | 25.2 |

From the results of the three experiments above, it can be seen that the received power of the normal operating channels is greater than 28 dBm, when completely broken (lost connection), it does not exceed 20 dBm, the range from 20 dBm to 28 dBm is the power drop area. The received power of the normal channels does not differ by more than 2 dBm. Based on these survey results, the power evaluation threshold (P_{Thr}) and power deviation threshold (Diff_{Thr}) are selected as follows:

$${P}_{T h r} = 28 ( dBm ) , {Diff}_{T h r} = 2 ( dBm )$$

### The Effectiveness of the Invention

The real-time transmission quality measurement method applied to 5G radio transceiver systems plays an important role in monitoring the operating status of the system, allowing for immediate error detection, thereby having a solution to ensure the system is always in a stable operating state. In addition, this method is deployed on both microprocessor platforms (ARM) and programmable logic hardware (FPGA), allowing for high-precision calculations, reducing processing latency, increasing real-time, and optimizing processing resources for 5G radio transceiver systems. Furthermore, the implementer can customize configuration parameters to serve different bandwidths, frequency bands, and numbers of antenna channels.

1. A real-time transmission line quality measurement method applied to a 5G radio transceiver system, including the following steps:
Step 1: transmit and receive reference signals on the 5G radio transceiver system as follows
a reference signal generator receives parameters from a central processing unit on a RRU (ARM), with the RRU being the 5G radio transceiver system:
Number of subcarriers: N_sub
Number of transmission-reception repetitions: L
5G radio transceiver identifier parameters: N_{cell_ID}
Number of antenna channels: N_ant
Number of Fast Fourier transform points: M
A Zadoff-Chu (ZC) sequence—s(n) used to generate reference data that is generated in the following formula:
$$s ( n ) = {e}^{{jN}_{{cell}_{ID}^{k}}} {\hat{r}}_{u , v} ( n ) , 0 \leq n \leq N\_sub$$
\hat{r}_{u,v}(n) called the root sequence, this sequence will be generated according to the following:
$${\hat{r}}_{u , v} ( n ) = {x}_{q} ( n mod {N}_{SC}^{RS} ) , 0 \leq n \leq N\_sub$$
the N_{SC}^{RS} value is always less than a value of the number of subcarriers in a system bandwidth (N_sub), this value is defined in the 3GPP standard for each bandwidth;
x_{q}(m) is called the original sequence, this sequence is calculated by the formula:
$${x}_{q} ( m ) = {e}^{- \frac{j π qm ( m + 1 )}{{N}_{SC}^{RS}}} , 0 \leq m \leq {N}_{SC}^{RS} - 1$$
a q index is calculated by the formula:
$$q = ⌊ \overline{q} + \frac{1}{2} ⌋ + v . {( - 1 )}^{⌊ 2 \overline{q} ⌋} , v = 0$$
a q̅ value is calculated as follows:
$$\overline{q} = {N}_{SC}^{RS} . \frac{u + 1}{31} , u = 0$$
the generated sequence—s(n) will be a complex matrix of size 1×N_{sub}, this is also the frequency domain reference signal—Xₙ^{k}x(t), this sequence will be converted to the time domain using iFFT fast inverse fourier transform and modulation OFDM; a time domain reference signal will be transmitted repeatedly spanning two OFDM symbols;
each OFDM symbol only transmits reference data once and transmits it on a single antenna channel; a reference signal—x(t) will be transmitted on a seventh and eighth OFDM symbols of a special time slot due to the known processing delay on the 5G radio transceiver system, after a period of time (Δt) a reference signal—yₙⁱ(t) will be received on a feedback data from the antenna;
currently, the seventh and eighth OFDM symbols of the special time slot are not scheduled for user transmission/reception, so reference data can be continuously transmitted/received at this time; this is the factor that helps to realize the continuous real-time monitoring of this monitoring method;
the signal—yₙⁱ(t) will be demodulated with OFDM and fast fourier transform to obtain a reference data sequence received in the frequency domain; due to the hardware characteristics always changing according to external influences (temperature, frequency, etc.), repeating this signal transmission and reception process many times on all antenna channels; the sequences Y_{n,i}^{k} will be saved in a random access memory (RAM) of the central processing unit on the RRU and an average will be calculated for each antenna channel to eliminate effects of system oscillation as well as increase accuracy of the method; for each antenna channel, we will obtain a representative reference data sequence on the feedback (Ŷₙ^{k}) line calculated according to the formula:
$${\overline{Y}}_{n}^{k} = \frac{1}{L} {\sum }_{i = 0}^{L - 1} {Y}_{n , i}^{k} , k = \overline{0 , N\_sub - 1} , n = \overline{0 , {N}_{ant} - 1}$$
the received signal will be amplitude-calibrated according to an absolute value of the complex number (R=1+1i) according to the formula:
$${\overline{Y}}_{n}^{k} = \frac{Abs ( R )}{Abs ( max ( {\overline{Y}}_{n}^{k} ) )} . {\overline{Y}}_{n}^{k} , k = \overline{0 , N\_sub - 1} , n = \overline{0 , {N}_{ant} - 1}$$
signal normalization is to separate the received data from background noise of an environment, eliminating an influence of transmitted power on the reference signal;
Step 2: estimate a channel response of each transmitting channel, calculate a received signal power on each channel:
the channel response (Hₙ^{k}) corresponding to each antenna channel on each subcarrier is calculated according to the following formula:
$${H}_{n}^{k} = \frac{{\overline{Y}}_{n}^{k}}{{X}_{n}^{k}} v {ó}^{′} ik = \overline{0 , N\_sub - 1} , n = \overline{0 , {N}_{ant} - 1}$$
the received signal power on each subcarrier of the antenna channels is calculated as follows:
$${P}_{n}^{k} = {( {H}_{n}^{k} )}^{2} v {ó}^{′} ik = \overline{0 , N\_sub - 1} , N\_sub$$
the signal power of each antenna channel is the sum of the powers of each subcarrier received on the feedback channel:
$${P}_{n} = {\sum }_{k = 0}^{{N}_{sub} - 1} {P}_{n}^{k} v {ó}^{′} i n = \overline{0 , {N}_{ant} - 1}$$
maximum power received during transmission of antenna channel:Nₐₙₜ
$$max {P}_{N \_ ant} = max \{ {P}_{n} \} v {ó}^{′} i n = \overline{0 , {N}_{ant} - 1}$$
power deviation of the antenna channels from the channel with the highest power is calculated by the formula:
$${diffP}_{n} = \vert max {P}_{N \_ ant} - {P}_{n} \vert , n = \overline{0 , {N}_{ant} - 1}$$
Step 3: evaluate the channel status
evaluate the quality of the transmission channel based on two criteria: the received reference signal power and the power deviation of the transmission channels;
this result is saved in the random access memory of the central processing unit on the RRU and will be transmitted to a DU 5G NR via a operation, administration and maintenance (OAM) line;
ARM configures two parameters: the received signal power threshold on the channel (P_{Thr}) and the power deviation of the channels compared to the channel with the largest received power (Diff_{Thr}) to the evaluation block; the threshold (P_{Thr}) is used to decide whether the transmitting channel emits a signal or not, the threshold (Diff_{Thr}) will indicate which channel has quality degradation;
the transmitting channel will be judged to be not emitting a signal (or not amplifying the emitted signal through the power amplifier block) when:
$${P}_{n} < {P}_{Thr} v {ó}^{′} i n = \overline{0 , {N}_{ant} - 1}$$
the transmitting channel will be considered degraded (signal gain reduction) when:
$$\{ \begin{matrix}{P}_{n} \geq {P}_{Thr} \\ {diffP}_{n} \geq {Diff}_{Thr}\end{matrix} , n = \overline{0 , {N}_{ant} - 1}$$
a channel is considered to be operating normally when the following conditions are satisfied:
$$\{ \begin{matrix}{P}_{n} \geq {P}_{Thr} \\ {diffP}_{n} < {Diff}_{Thr}\end{matrix} , n = \overline{0 , {N}_{ant} - 1} .$$
